(19) United States
(12) Patent Application Publication
(10) Pub. No.: US 2022/0288893 A1
(43) Pub. Date: Sep. 15, 2022

(54) LAMINATION METHOD FOR AUTOMOTIVE INTERIORS WITH DECREASED BEND STRESS AND IMPROVED HIT PERFORMANCE

(71) Applicant: CORNING INCORPORATED, CORNING, NY (US)

(72) Inventors: Dhananjay Joshi, Painted Post, NY (US); Khaled Layouni, Fontainebleau (FR); Jinfa Mou, Pittsford, NY (US); Jong Se Park, San Jose, CA (US)

(21) Appl. No.: 17/632,344

(22) PCT Filed: Aug. 3, 2020
(86) PCT No.: PCT/US2020/044699

§ 371 Date: Feb. 2, 2022

Related U.S. Application Data
(60) Provisional application No. 62/884,954, filed on Aug. 9, 2019.
(60) Provisional application No. 62/967,779, filed on Jan. 30, 2020.

(51) Int. Cl. B32B 17/10; B32B 1/00; B32B 7/12; C03B 23/035

(52) U.S. Cl. CPC B32B 17/10036; B32B 1/00; B32B 7/12; B32B 17/10733; B32B 17/10743; B32B 17/1077; B32B 17/10798; B32B 17/10889; C03B 23/0357; B32B 2605/003; B32B 2307/558; B32B 2457/20; B32B 2307/54; B32B 2307/732; B32B 2307/416

(57) ABSTRACT

A method for forming a vehicle interior system. In the method, a first glass layer is provided in which the first glass layer has a first major surface and a second major surface. The second major surface is opposite to the first major surface. A second glass layer is provided in which the second glass layer has a third major surface and a fourth major surface. The fourth major surface is opposite to the third major surface. The second major surface is bonded to the third major surface with an adhesive layer to form a glass laminate. The glass laminate is placed on a mold, and the glass laminate is formed at a temperature below a glass transition temperature of each glass layer to form a first curvature.

### CROSS-REFERENCE TO RELATED APPLICATIONS

This application claims the benefit of priority under 35 U.S.C. § 119 of U.S. Provisional Application Ser. No. 62/967,779 filed on Jan. 30, 2020 and U.S. Provisional Application Ser. No. 62/884,954 filed on Aug. 9, 2019 the content of which are relied upon and incorporated herein by reference in their entirety.

### BACKGROUND

The disclosure relates to vehicle interior systems including at least two layers of glass and methods for forming the same.

Vehicle interiors include curved surfaces and can incorporate displays in such curved surfaces. The materials used to form such curved surfaces are typically limited to polymers, which do not exhibit the same durability and optical performance as glass. As such, curved glass layers are desirable, especially when used as covers for displays. Existing methods of forming such curved glass layers, such as thermal forming, have drawbacks including high cost, optical distortion, and surface marking. Accordingly, Applicant has identified a need for vehicle interior systems that can incorporate a curved glass layer in a cost-effective manner and without problems typically associated with glass thermal forming processes.

### SUMMARY

According to an aspect, embodiments of the disclosure relate to a method for forming a vehicle interior system. In the method, a first glass layer is provided in which the first glass layer has a first major surface and a second major surface. The second major surface is opposite to the first major surface. A second glass layer is provided in which the second glass layer has a third major surface and a fourth major surface. The fourth major surface is opposite to the third major surface. The second major surface is bonded to the third major surface an adhesive layer to form a glass laminate. The glass laminate is placed on a mold, and the glass laminate is formed at a temperature below a glass transition temperature of each glass layer to form a first curvature.

According to another aspect, embodiments of the disclosure relate to a vehicle interior system that includes a glass laminate having a display region and a non-display region. The glass laminate includes a first glass layer having a first major surface and a second major surface with the second major surface being opposite to the first major surface and a second glass layer having third major surface and a fourth major surface with the fourth major surface being opposite to the third major surface. The glass laminate also includes an adhesive layer disposed between the second major surface and the third major surface that bonds the first glass layer to the second glass layer. A display is bonded to the glass laminate in a display region of the glass laminate. When a probe applying 10 N of force to the glass laminate is moved across the glass laminate, a maximum brightness of light from the display measured by the probe is within 20% of the minimum brightness measured by the probe.

According to still another aspect, embodiments of the disclosure relate to a glass laminate for a vehicle interior system. The glass laminate includes a first glass layer having a first curved surface and a second curved surface. The first curved surface and the second curved surface are on opposite sides of the first glass layer and define a first thickness of the first glass layer. The glass laminate also includes a second glass layer having third curved surface and a fourth curved surface. The third curved surface and the fourth curved surface are on opposite sides of the second glass layer and define a second thickness of the second glass layer. An adhesive layer is disposed between the second curved surface and the third curved surface, and the adhesive layer bonds the first glass layer to the second glass layer The first curved surface, the second curved surface, the third curved surface, and the fourth curved surface define at least a first curvature of the glass laminate. A maximum deceleration of a head form impacting the first major surface of the first glass layer does not exceed 80 g for 3 ms continuously when tested according to FMVSS201.

Additional features and advantages will be set forth in the detailed description which follows, and in part will be readily apparent to those skilled in the art from that description or recognized by practicing the embodiments as described herein, including the detailed description which follows, the claims, as well as the appended drawings.

It is to be understood that both the foregoing general description and the following detailed description are merely exemplary, and are intended to provide an overview or framework to understanding the nature and character of the claims.

### BRIEF DESCRIPTION OF THE DRAWINGS

The accompanying drawings are included to provide a further understanding, and are incorporated in and constitute a part of this specification. The drawings illustrate one or more embodiment(s), and together with the description serve to explain principles and operation of the various embodiments. In the drawings:

FIG. 1 depicts a perspective view of a glass laminate structure, according to exemplary embodiments;

FIG. 2 depicts a schematic diagram of the method of forming the glass laminate structure, according to an exemplary embodiment;

FIG. 3 depicts the maximum bending stress for glass laminate structures according to exemplary embodiments as compared to a monolith glass layer;

FIG. 4 depicts a graph of maximum bending stress for glass laminate strictures at a variety of thickness ratios according to exemplary embodiments as compared to a monolith glass layer;

FIG. 5 depicts a graph of the normalized bending stiffness for glass laminate structures at a variety of thickness ratios according to exemplary embodiments as compared to a monolith glass layer;

FIG. 6 depicts a table of maximum bending stress for different configurations of symmetrical and asymmetrical glass laminate structures according to exemplary embodiments;

FIG. 7 depicts a graph of the allowable bend radius as a function of total thickness for glass laminate structures according to exemplary embodiments as compared to monolith glass sheets;

FIG. 8 depicts an experimental setup for headform impact testing of the glass laminate structure, according to an exemplary embodiment;

FIGS. 9A and 9B depict comparative examples of headform impact testing for single glass plies having a thickness of 0.7 mm;

FIGS. 10A and 10B depict headform impact testing for the glass laminate structure having a total glass thickness of 1.1 mm, according to an exemplary embodiment;

FIGS. 11A and 11B depict exemplary touch MURA measurements for coverglass layers having thicknesses of 0.55 mm and 0.7 mm, respectively; and

FIG. 12 depicts a vehicle having vehicle interior systems into which the glass laminate structure may be incorporated, according to an exemplary embodiment.

### DETAILED DESCRIPTION

Reference will now be made in detail to various embodiments of a glass laminate structure for vehicle interiors, examples of which are illustrated in the accompanying drawings. In general, a vehicle interior system may include a variety of different curved surfaces that are designed to be transparent, such as curved display surfaces and curved non-display glass covers, and the present disclosure provides such curved glass surfaces as well as methods for forming these curved surfaces from two layers of glass material. Forming curved vehicle surfaces from two layers of glass material provides a number of advantages compared to the typical curved plastic panels that are conventionally found in vehicle interiors. For example, glass is typically considered to provide enhanced functionality and user experience in many curved cover material applications, such as display applications and touch screen applications, compared to plastic cover materials.

As will be discussed in more detail below, Applicant has developed a glass article and related manufacturing processes that provide an efficient and cost-effective way to form an article, such as a curved glass display and non-display surfaces for a vehicle interior system, utilizing a method involving cold forming two layers of glass simultaneously, which allows for tighter bend radiuses to be achieved. Advantageously, the glass laminate structure having two glass layers also meets or exceeds relevant headform impact testing (HIT) standards. Additionally, the two layer glass laminate structure combines the advantages of design flexibility (allowing for tighter bend radiuses) with better user interaction in the form of reduced touch MURA (i.e., more uniform brightness in the touch zone of a touch screen display). These and other aspects and advantages will be discussed in greater detail in relation to the exemplary embodiments provided below. These embodiments are illustrative in nature and should not be considering limiting.

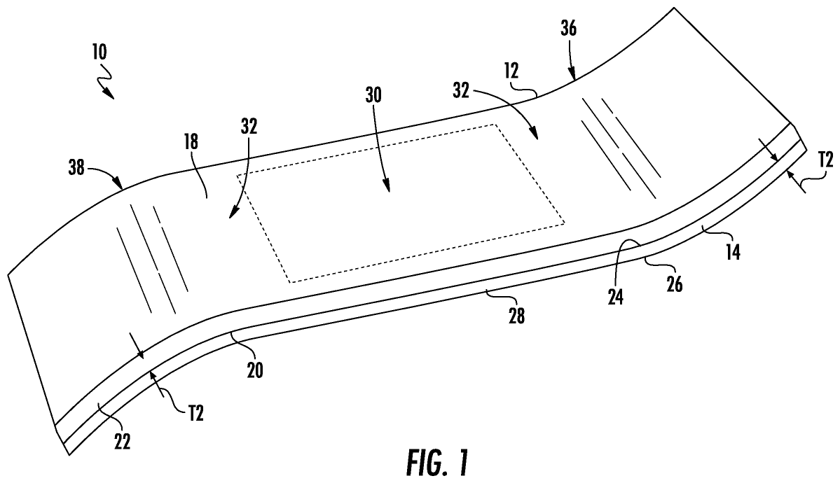

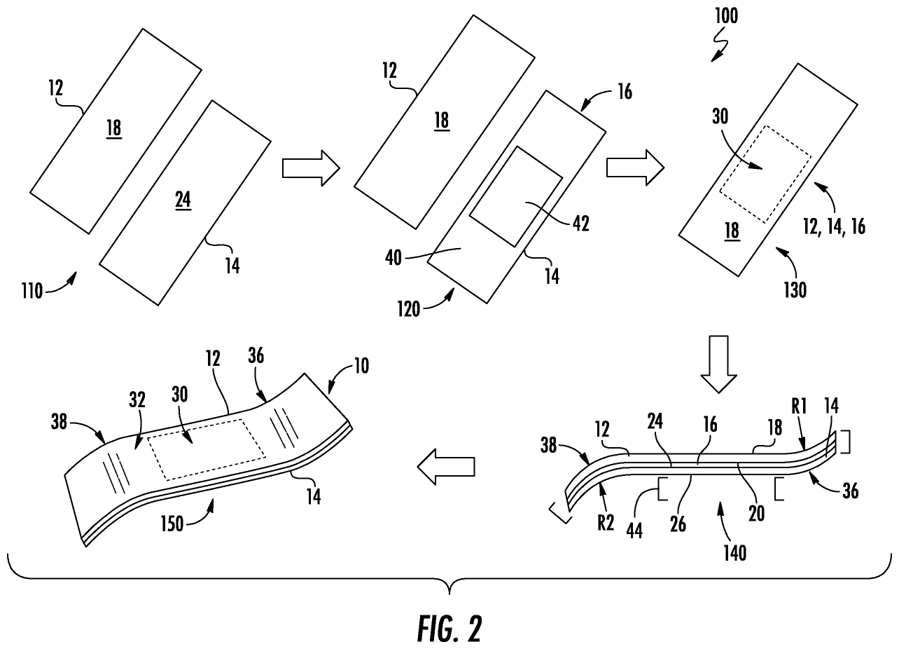

FIG. 1 depicts an embodiment of a glass laminate structure 10. As can be seen in FIG. 1, the glass laminate structure 10 includes a first glass layer 12 and a second glass layer 14 joined by an adhesive layer 16 (shown in FIG. 2). In particular, the first glass layer 12 has a first major surface 18 and a second major surface 20 opposite to the first major surface 18. A first minor surface 22 joins the first and second major surfaces 18, 20. The first major surface 18 and the second major surface 20 define a thickness T1 of the first glass layer 12. In embodiments, the thickness T1 is, on average, from about 0.1 mm to about 2.5 mm. In other embodiments, the thickness T1 is, on average, from about 0.55 mm to about 2 mm, and in still other embodiments, the thickness T1 is, on average, from about 0.7 mm to about 1.5 mm.

The second glass layer 14 has a third major surface 24 and a fourth major surface 26 opposite to the fourth major surface 24. A second minor surface 28 joins the third and fourth major surfaces 24, 26. The third major surface 24 and the fourth major surface 26 define a thickness T2 of the second glass layer 14. In embodiments, the thickness T2 is, on average, from about 0.1 mm to about 2.5 mm. In other embodiments, the thickness T2 is, on average, from about 0.55 mm to about 2 mm, and in still other embodiments, the thickness T2 is, on average, from about 0.7 mm to about 1.5 mm. Further, in embodiments, the thickness T1 may be the same as the thickness T2, and in other embodiments, the thickness T1 may be different from the thickness T2.

In one or more embodiments, T1 and/or T2 is that is in a range that is greater than about 0.125 mm (e.g., about 0.13 mm or greater, about 0.13 mm or greater, about 0.13 mm or greater, about 0.13 mm or greater, about 0.13 mm or greater, about 0.13 mm or greater, about 0.13 mm or greater, about 0.13 mm or greater, about 0.13 mm or greater, about 0.13 mm or greater, about 0.13 mm or greater, about 0.13 mm or greater, about 0.13 mm or greater, about 0.13 mm or greater, about 0.13 mm or greater. For example, the thickness may be in a range from about 0.1 mm to about 2.5 mm, from about 0.15 mm to about 2.5 mm, from about 0.2 mm to about 2.5 mm, from about 0.25 mm to about 2.5 mm, from about 0.3 mm to about 2.5 mm, from about 0.35 mm to about 2.5 mm, from about 0.4 mm to about 2.5 mm, from about 0.45 mm to about 2.5 mm, from about 0.5 mm to about 2.5 mm, from about 0.55 mm to about 2.5 mm, from about 0.6 mm to about 2.5 mm, from about 0.65 mm to about 2.5 mm, from about 0.7 mm to about 2.5 mm, from about 0.8 mm to about 2.5 mm, from about 0.9 mm to about 2.5 mm, from about 1 mm to about 2.5 mm, from about 1.1 mm to about 1.2 mm, from about 1.3 mm to about 2.5 mm, from about 1.4 mm to about 2.5 mm, from about 1.5 mm to about 2.5 mm, from about 2 mm to about 2.5 mm, from about 0.1 mm to about 2.4 mm, from about 0.1 mm to about 2.3 mm, from about 0.1 mm to about 2.2 mm, from about 0.1 mm to about 2.1 mm, from about 0.1 mm to about 2 mm, from about 0.1 mm to about 1.9 mm, from about 0.1 mm to about 1.8 mm, from about 0.1 mm to about 1.7 mm, from about 0.1 mm to about 1.6 mm, from about 0.1 mm to about 1.5 mm, from about 0.1 mm to about 1.4 mm, from about 0.1 mm to about 1.3 mm, from about 0.1 mm to about 1.2 mm, from about 0.1 mm to about 1.1 mm, from about 0.1 mm to about 1.05 mm, from about 0.1 mm to about 1 mm, from about 0.1 mm to about 0.95 mm, from about 0.1 mm to about 0.9 mm, from about 0.1 mm to about 0.85 mm, from about 0.1 mm to about 0.8 mm, from about 0.1 mm to about 0.75 mm, from about 0.1 mm to about 0.7 mm, from about 0.1 mm to about 0.65 mm, from about 0.1 mm to about 0.6 mm, from about 0.1 mm to about 0.55 mm, from about 0.1 mm to about 0.5 mm, from about 0.1 mm to about 0.4 mm, from about 0.1 mm to about 0.3 mm, from about 0.1 mm to about 0.2 mm, or from about 0.3 mm to about 0.7 mm.

In one or more embodiments, the thickness of the first glass layer and/or the second glass layer is substantially uniform. For example, the thickness of the cover substrate does not vary by more than ±10%, 5% or 2% across the total surface area of the first major surface, the second major surface, the third major surface and/or the fourth major surface. In one or more embodiments, the thickness is substantially constant (within ±1% of the average thickness) across 90%, 95% or 99% of the total surface area of the first major surface, the second major surface, the third major surface and/or the fourth major surface.

In one or more embodiments, the first glass layer and/or the second glass layer has a width (W) in a range from about 5 cm to about 250 cm, from about 10 cm to about 250 cm, from about 15 cm to about 250 cm, from about 20 cm to about 250 cm, from about 25 cm to about 250 cm, from about 30 cm to about 250 cm, from about 35 cm to about 250 cm, from about 40 cm to about 250 cm, from about 45 cm to about 250 cm, from about 50 cm to about 250 cm, from about 55 cm to about 250 cm, from about 60 cm to about 250 cm, from about 65 cm to about 250 cm, from about 70 cm to about 250 cm, from about 75 cm to about 250 cm, from about 80 cm to about 250 cm, from about 85 cm to about 250 cm, from about 90 cm to about 250 cm, from about 95 cm to about 250 cm, from about 100 cm to about 250 cm, from about 110 cm to about 250 cm, from about 120 cm to about 250 cm, from about 130 cm to about 250 cm, from about 140 cm to about 250 cm, from about 150 cm to about 250 cm, from about 5 cm to about 240 cm, from about 5 cm to about 230 cm, from about 5 cm to about 220 cm, from about 5 cm to about 210 cm, from about 5 cm to about 200 cm, from about 5 cm to about 190 cm, from about 5 cm to about 180 cm, from about 5 cm to about 170 cm, from about 5 cm to about 160 cm, from about 5 cm to about 150 cm, from about 5 cm to about 140 cm, from about 5 cm to about 130 cm, from about 5 cm to about 120 cm, from about 5 cm to about 110 cm, from about 5 cm to about 110 cm, from about 5 cm to about 100 cm, from about 5 cm to about 90 cm, from about 5 cm to about 80 cm, or from about 5 cm to about 75 cm.

In one or more embodiments, the first glass layer and/or the second glass layer has a length (L) in a range from about 5 cm to about 250 cm, from about 10 cm to about 250 cm, from about 15 cm to about 250 cm, from about 20 cm to about 250 cm, from about 25 cm to about 250 cm, from about 30 cm to about 250 cm, from about 35 cm to about 250 cm, from about 40 cm to about 250 cm, from about 45 cm to about 250 cm, from about 50 cm to about 250 cm, from about 55 cm to about 250 cm, from about 60 cm to about 250 cm, from about 65 cm to about 250 cm, from about 70 cm to about 250 cm, from about 75 cm to about 250 cm, from about 80 cm to about 250 cm, from about 85 cm to about 250 cm, from about 90 cm to about 250 cm, from about 95 cm to about 250 cm, from about 100 cm to about 250 cm, from about 110 cm to about 250 cm, from about 120 cm to about 250 cm, from about 130 cm to about 250 cm, from about 140 cm to about 250 cm, from about 150 cm to about 250 cm, from about 5 cm to about 240 cm, from about 5 cm to about 230 cm, from about 5 cm to about 220 cm, from about 5 cm to about 210 cm, from about 5 cm to about 200 cm, from about 5 cm to about 190 cm, from about 5 cm to about 180 cm, from about 5 cm to about 170 cm, from about 5 cm to about 160 cm, from about 5 cm to about 150 cm, from about 5 cm to about 140 cm, from about 5 cm to about 130 cm, from about 5 cm to about 120 cm, from about 5 cm to about 110 cm, from about 5 cm to about 110 cm, from about 5 cm to about 100 cm, from about 5 cm to about 90 cm, from about 5 cm to about 80 cm, or from about 5 cm to about 75 cm.

In various embodiments, first major surface 18 and/or the second major surface 20 of the first glass layer 12 or the third major surface 24 and/or the fourth major surface 26 of the second glass layer 14 includes one or more surface treatments or layers. The surface treatment may cover at least a portion of any or all of the first major surface 18, the second major surface 20, the third major surface 24, or the fourth major surface 26. Exemplary surface treatments include anti-glare surfaces/coatings, impact-resistant coating, anti-reflective surfaces/coatings, and an easy-to-clean surface coating/treatment. In one or more embodiments, at least a portion of one or more of the major surfaces includes any one, any two, any three or all four of an anti-glare surface/coating, an anti-reflective surface/coating, an impact-resistant coating, and easy-to-clean coating/treatment. For example, first major surface 18 may include an anti-glare surface and second major surface 20 may include an anti-reflective surface. In another example, the first major surface 18 includes an anti-glare surface and the second major surface 20 includes an anti-reflective surface. In yet another example, the second major surface 20 comprises either one of or both of the anti-glare surface and the anti-reflective surface, and the first major surface 18 includes the easy-to-clean coating. In one or more embodiments, the anti-glare surface includes an etched surface. In one or more embodiments, the anti-reflective surface includes a multi-layer coating.

In embodiments, the first glass layer 12 may also include a decorative layer on the first major surface 18 and/or second major surface 20. In embodiments, the decorative layer may include a solid color or a pattern containing multiple colors. The decorative layer may be comprised of an ink, pigment, or dye. In embodiments, the decorative layer may be a design resembling a wood-grain, a brushed metal finish, a graphic, a portrait, or a logo, among other possible designs. In embodiments, the decorative layer is printed onto the glass layer.

As will be discussed below, these surface treatments can be applied prior to forming while the glass layers 12, 14 are planar, and because the glass layers are cold-formed, the subsequent forming will not remove or cause deterioration of the surface treatments.

The adhesive layer 16 (shown in FIG. 2) is disposed between the second major surface 20 and the third major surface 24 and bonds the first glass layer 12 to the second glass layer 14. In embodiments, the adhesive layer 16 includes more than one adhesive material between the second major surface 20 and the third major surface 24. For example, in embodiments, the laminate structure 10 defines display regions 30 and non-display regions 32. In embodiments, the adhesive layer 16 includes a first adhesive in the non-display region 32 and second adhesive in the display region 30. In one or more embodiments, the first adhesive comprises a structural adhesive. In one or more embodiments, the second adhesive comprises an optically clear adhesive (OCA). In embodiments, the second adhesive used in the adhesive layer 16 has a shear modulus of 0.1 MPa (100 kPa) or less, such as in the range of 10 kPa to 100 kPa. As will be discussed below, the low shear modulus of the adhesive layer 16 effectively decouples the first glass layer 12 from the second glass layer 14, allowing for tighter bend radiuses and decreasing bending stress in the laminate structure 10. As used herein, shear modulus (G) is determined by Equation (1), in which E is the Young's Modulus, and v is Poisson's ratio.

G=E/[2*(1+v)] Equation (1):

Further, in embodiments, the adhesive layer 16 has a thickness in the range of 0.1 mm to 0.3 mm.

In embodiments, the second adhesive is selected to have good transmission so as not to obscure a display mounted behind the glass laminate structure 10. In embodiments, the OCA is used and may be selected from an acrylic-based or silicone-based adhesive. As mentioned, in one or more embodiments, the OCA may comprise a Young's modulus of 10 kPa to 100 kPa (more particularly, in embodiments, 30 kPa or lower), which allows stress relaxation between the first glass layer 12 and the second glass layer 14 for lower biaxial bending stress than a single glass ply. In one or more embodiments, the Young's modulus of the second adhesive is in a range from about 10 kPa to about 90 kPa, from about 10 kPa to about 80 kPa, from about 10 kPa to about 70 kPa, from about 10 kPa to about 60 kPa, from about 10 kPa to about 50 kPa, from about 10 kPa to about 40 kPa, from about 10 kPa to about 20 kPa, from about 10 kPa to about 20 kPa, from about 20 kPa to about 100 kPa, from about 30 kPa to about 100 kPa, from about 40 kPa to about 100 kPa, from about 15 kPa to about 50 kPa, from about 20 kPa to about 40 kPa, or from about 25 kPa to about 35 kPa.

In embodiments, the first adhesive has a higher Young's modulus than the second adhesive. For example, in embodiments, the first adhesive is selected to have a Young's modulus of 100 MPa or greater (e.g., from about 100 MPa to about 2000 MPa, from about 200 MPa to about 2000 MPa, from about 300 MPa to about 2000 MPa, from about 400 MPa to about 2000 MPa, from about 500 MPa to about 20000 MPa, from about 600 MPa to about 2000 MPa, from about 700 MPa to about 2000 MPa, from about 800 MPa to about 2000 MPa, from about 900 MPa to about 2000 MPa, from about 1000 MPa to about 2000 MPa, from about 1500 MPa to about 2000 MPa, from about 100 MPa to about 1750 MPa, from about 100 MPa to about 1500 MPa, from about 100 MPa to about 1250 MPa, from about 100 MPa to about 1000 MPa, from about 100 MPa to about 900 MPa, from about 100 MPa to about 800 MPa, from about 100 MPa to about 700 MPa, from about 100 MPa to about 600 MPa, from about 100 MPa to about 500 MPa, or from about 100 MPa to about 400 MPa. The first adhesive holds the two glass layers 12, 14 tight around the edges. Without being bound by theory, the use of the first adhesive with the described Young's modulus improves impact performance, including headform impact test (HIT) according to FMVSS201 for automotive interiors. Additionally, the structural adhesive can be used to prevent edge failure that may result from localized bending compared to a thin single glass ply.

In embodiments, the first adhesive may be described as a structural adhesive. In one or more embodiments, the first adhesive may include one or more pressure-sensitive adhesives, such as 3M VHB (available from 3M, St. Paul, Minn.) and Tesa® (available from tesa SE, Norderstedt, Germany), or UV curable adhesives, such as DELO DUALBOND® MF4992 (available from DELO Industrial Adhesives, Windach, Germany). In embodiments, exemplary adhesives for the first adhesive include toughened epoxy, flexible epoxy, acrylics, silicones, urethanes, polyurethanes, and silane modified polymers. In specific embodiments, the first adhesive includes one or more toughened epoxies, such as EP21TDCHT-LO (available from Masterbond®, Hackensack, N.J.), 3M Scotch-Weld™ Epoxy DP460 Off-White (available from 3M, St. Paul, Minn.). In other embodiments, the first adhesive includes one or more flexible epoxies, such as Masterbond EP21TDC-2LO (available from Masterbond®, Hackensack, N.J.), 3M Scotch-Weld™ Epoxy 2216 B/A Gray (available from 3M, St. Paul, Minn.), and 3M Scotch-Weld™ Epoxy DP125. In still other embodiments, the first adhesive includes one or more acrylics, such as LORD® Adhesive 410/Accelerator 19 w/LORD® AP 134 primer, LORD® Adhesive 852/LORD® Accelerator 25 GB (both being available from LORD Corporation, Cary, N.C.), DELO PUR SJ9356 (available from DELO Industrial Adhesives, Windach, Germany), Loctite® AA4800, Loctite® HF8000. TEROSON® MS 9399, and TEROSON® MS 647-2C (these latter four being available from Henkel AG & Co. KGaA, Dusseldorf, Germany), among others. In yet other embodiments, the first adhesive includes one or more urethanes, such as 3M Scotch-Weld Urethane DP640 Brown and 3M Scotch-Weld™ Urethane DP604, and in still further embodiments, the first adhesive includes one or more silicones, such as Dow Corning® 995 (available from Dow Corning Corporation, Midland, Mich.). In embodiments, the first adhesive may include at least two of any of the aforementioned adhesives, including pressure-sensitive adhesives, UV curable adhesives, toughened epoxies, flexible epoxies, acrylics, silicones, urethanes, polyurethanes, and silane modified polymers.

As can be seen in FIG. 1, the glass laminate structure 10 defines includes at least a first curve 36 having a first radius of curvature R1 (shown in FIG. 2). With respect to the first major surface 18, the first curve 36 defines a concave curvature having a radius R1 of from 100 mm to 5 m. In the embodiment shown in FIG. 1, the laminate structure includes a second curve 38 having a second radius of curvature R2 (shown in FIG. 2), and with respect to the first major surface 18, the second curve 38 defines a convex curvature having a radius R2 of from 100 mm to 5 m. While FIG. 1 depicts a combination of a concave curve and a convex curve, the laminate structure 10, in other embodiments, includes only one curve, more than two curves, multiple concave curves, and/or multiple convex curves.

FIG. 2 depicts a method 100 for forming the glass laminate structure 10 of FIG. 1. In a first step 110, the first glass layer 12 and the second glass layer 14 are provided in a flat, planar (i.e., unbent or unformed) state. In a second step 120, the adhesive layer 16 is applied to one of the first glass layer 12 or the second glass layer 14. As can be seen in FIG. 2, the adhesive layer 16 includes a first adhesive 40 applied around the perimeter of the second glass layer 14 and an second adhesive 42 on the interior of the second glass layer 14. In a third step 130, the glass layers 12, 14 are laminated together such that the adhesive layer 16 is positioned between the first glass layer 12 and the second glass layer 14. In one or more embodiments, the first adhesive 40 comprises a structural adhesive as described herein. In one or more embodiments, the second adhesive 42 comprises an OCA, as described herein.

In a fourth step 140, the laminated glass layers 12, 14 are cold formed over a mold 44. In embodiments, cold-forming is performed at a temperature below the glass transition temperature of the first and second glass layers 12, 14. More particularly, in embodiments, cold-forming is performed at a temperature below 200° C., and in still other embodiments, cold-forming is performed at a temperature below 100° C. In particular embodiments, cold-forming is performed at room temperature. In embodiments, the mold 44 may be vacuum formed (e.g., using a vacuum chuck or a vacuum bag), press molded, etc. While on the mold 44, the adhesive layer 16 is allowed to cure to bond the first glass layer 12 to the second glass layer 14. Once cured, the glass laminate structure 10 will maintain its curved shape because of stress rebalancing between the layers 12, 14. That is, unlike conventional cold-formed glass structures, the glass laminate structure 10 of the present disclosure does not need to be bonded to a frame in order to maintain its curved shape. Advantageously, the glass laminate structure 10 comprising two glass layers 12, 14 can achieve a tighter bend radius than a conventional laminate that includes only a single glass layer.

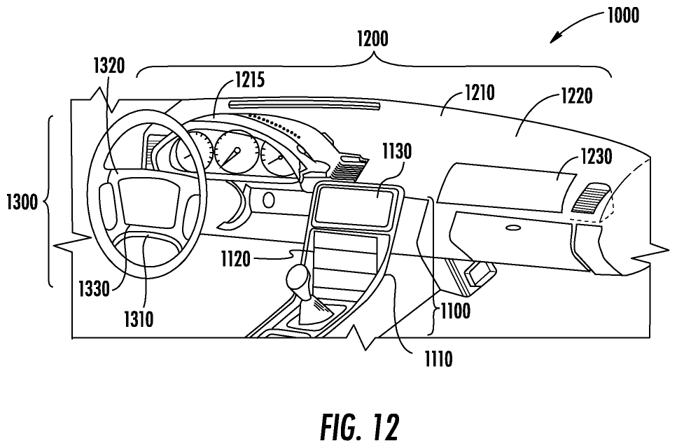

In a fifth step 150, the finished glass laminate structure 10 is removed from the mold. Thereafter, a display may be bonded (e.g., using the second adhesive, which may comprise an OCA) to the rear surface (fourth major surface 26) of the glass laminate structure in the display area 30. For example, the display may be at least one of a light-emitting diode (LED) display, an organic LED display, a liquid crystal display, or a plasma display. Further, the glass laminate structure 10 (including with bonded display) can be installed in a vehicle interior system (e.g., as shown in FIG. 12). Advantageously and as opposed to other conventional glass laminate structures, the glass laminate structure 10 of the present disclosure is self-supporting such that the glass layers 12, 14 do not need to be mounted to a frame. Instead, the glass laminate structure can be incorporated into a vehicle interior system using, e.g., double-sided adhesive.

Advantageously, the glass laminate structure 10 prevents crack propagation. For example, if the first glass layer 12 is impacted such that a crack develops in the first layer 12, the adhesive layer 16 (especially the relatively softer second adhesive 42) will substantially diminish the likelihood that the crack will propagate to the second glass layer 14. Further, any cracked pieces of glass formed in one of the glass layers 12, 14 will be held together by the adhesive layer 16 and the other uncracked layer 12, 14.

In comparison to a monolith glass article of the same thickness, the glass laminae structure 10 disclosed herein has many superior properties that will be discussed more fully below. In short, the glass laminate structure 10 exhibits a lower bending stress by about 20% to 30% and even up to about 50% if a low-shear modulus adhesive is used. Further, the glass laminate structure 10 has a bending stiffness that is less than half the bending stiffness of a monolith having the same thickness, which means that less force is required to cold-bend the glass layers 12, 14. Further, tighter bend radiuses can be achieved. In particular, for glass laminate structures 10 having a thickness in the range of 0.7 mm to 2.1 mm, the bend radius can be lowered by 10 mm to 80 mm as compared to monolith glass layers.

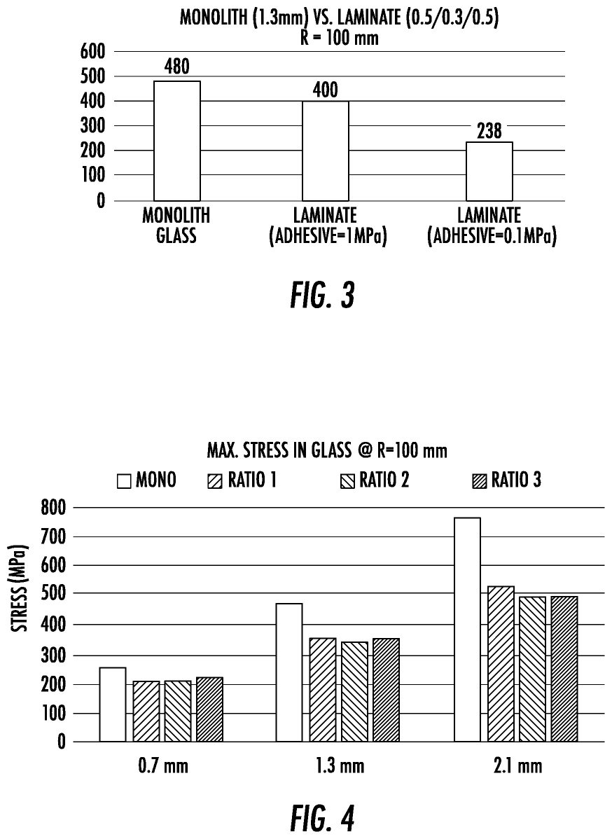

In the following discussion and with respect to FIGS. 3-7, the properties of the glass laminate structure 10 are described, including in comparison to a monolith glass layer. As mentioned above, the glass laminate structure 10 is able to reduce the bending stress as compared to a monolith glass layer by decoupling the first glass layer 12 from the second glass layer 14 via the adhesive layer 16. Thus, the glass laminate structure 10 bends more like two thinner glass layers than one thicker glass layer. FIG. 3 depicts the effect that the adhesive layer 16 has on the bending stress of a monolith as compared to a first laminate having an adhesive layer with a shear modulus of 1 MPa and as compared to a second laminate having an adhesive layer with a shear modulus of 0.1 MPa. The bending stress was calculated using finite element analysis. Each of the specimens had a thickness of 1.3 mm. The monolith was a single layer of glass, and each laminate included two 0.5 mm glass layers with a 0.3 mm adhesive layer.

As can be seen in FIG. 3, the monolith had the largest bending stress of 480 MPa at a bend radius of 100 mm. The first laminate with the higher shear modulus adhesive layer exhibited a bending stress lower than the monolith at 400 MPa, but the second laminate having the lower shear modulus exhibited the most significant reduction in bending stress, which was at 238 MPa. Accordingly, FIG. 3 demonstrates that the laminate structure lowers bending stress as compared to the monolith, and FIG. 3 also demonstrates that the choice of adhesive also has a significant effect on the bending stress. In particular, choosing an adhesive with a shear modulus of 0.1 MPa (100 kPa) or less can lead to a 50% reduction in bending stress.

In addition to the shear modulus of the adhesive layer, the effect of the adhesive layer thickness on the bending stress in the laminate was also determined. The bending stress of the first laminate having two 0.3 mm glass layers and a 0.1 mm adhesive layer was compared to the bending stress of a second laminate having two 0.3 mm glass layers and a 0.3 mm adhesive layer. The bending stress of the laminate having the thicker adhesive layer was 6% lower than the bending stress of the laminate having the thinner adhesive layer. A similar result was achieved for laminates having 1.0 mm glass layers. In particular, the laminate having the 0.3 mm thick adhesive layer exhibited a bending stress that was 11% lower than the bending stress of the laminate having the 0.1 mm thick adhesive layer. Accordingly, in general, a laminate having an adhesive layer with a relatively lower shear modulus and a relatively greater thickness will have a lower bending stress than a laminate having an adhesive layer with a relatively higher shear modulus and a relatively lesser thickness.

Additionally, the effect of glass layer asymmetry on bending stress was determined and compared to a monolith glass layer. Table 1, below, provides the particulars and bending stress for the thicknesses of the monoliths and laminates considered. In each of the laminates, an second adhesive comprising an OCA having a shear modulus of about 0.1 MPa was considered.

TABLE 1
Stress in monolith vs. laminates having various thickness ratios at radius of 100 mm

| Total | Monolith | Thickness | Max. | Thickness | Max. | Thickness | Max |
|---|---|---|---|---|---|---|---|
| Thickness | Stress | Ratio of 1 | Stress | Ratio of 2 | Stress | Ratio of 3 | Stress |
| (mm) | (MPa) | (mm) | (MPa) | (mm) | (MPa) | (mm) | (MPa) |
| 0.7 | 267.2 | 0.3/0.1/0.3 | 209 | 0.4/0.1/0.2 | 213 | 0.45/0.1/0.15 | 223 |
| 1.3 | 479.1 | 0.6/0.1/0.6 | 354 | 0.8/0.1/0.4 | 342 | 0.9/0.1/0.3 | 351 |
| 2.1 | 758.3 | 1.0/0.1/1.0 | 530 | 1.33/0.1/0.67 | 491 | 1.5/0.1/0.5 | 495 |

The thickness ratio slash lines refer to the thickness of the first glass layer 12, the adhesive layer 16, and the second glass layer 14. Thus, for laminate Ratio 1 at 0.7 mm total thickness, the first glass layer 12 and the second glass layer 14 each had a thickness of 0.3 mm, and the adhesive layer 16 had a thickness of 0.1 mm. The bending stress is also depicted graphically in FIG. 4. As can be seen in Table 1 and in FIG. 4, the laminates at any of Ratios 1-3 all exhibited a lower bending stress than the monoliths for all total thicknesses. Further, for the thicknesses 1.3 mm and 2.1 mm, the asymmetrical laminates (Ratios 2 and 3) had a lower bending stress than the symmetrical laminates (Ratio 1). At the thickness of 0.7 mm, the bending stress was lowest for the symmetrical laminate (Ratio 1); although the difference in bending stress was not substantial. Accordingly, as the total thickness increases, the laminate structure exhibits greater reduction in bending stress relative to a monolith of the same thickness, and also as the total thickness increases, the reduction in bending stress of asymmetric laminates as compared to symmetric laminates also becomes more pronounced.

FIG. 5 depicts the bending stiffness of the laminates normalized to the bending stiffness of the monolith. The bending stiffness was determined based on a bend radius of 100 mm. As the laminates increase in thickness, the normalized bending stiffness decreases. In particular, at the thicknesses of 1.3 mm and 2.1 mm, the bending stiffness is less than about 60% of the bending stiffness of a monolith having the same thickness. Again, it can be seen that the effect of laminate structure, and in particular asymmetric laminate structure, is enhanced as the total thickness increases.

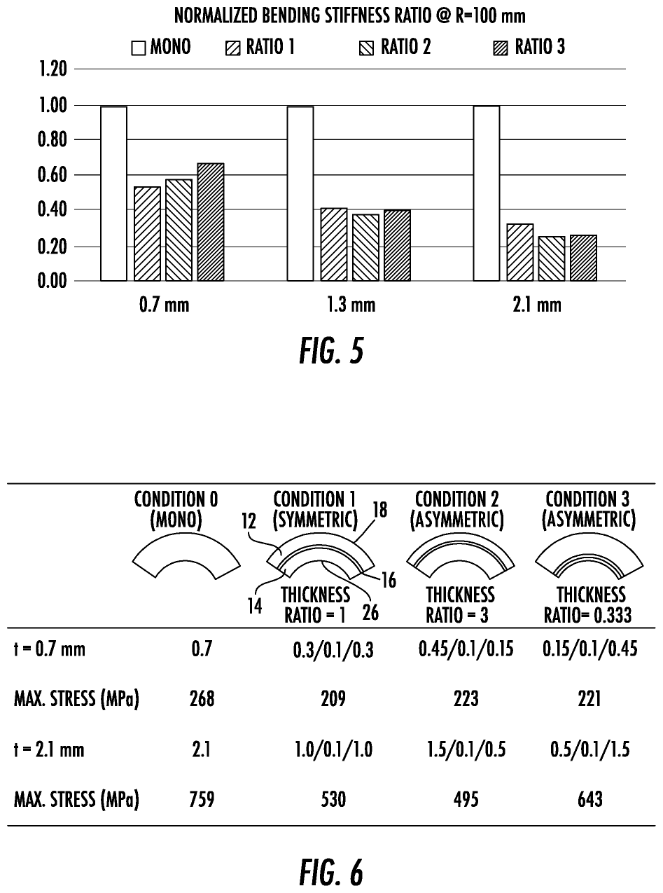

FIG. 6 depicts a table considering the effect of the glass thickness on the first glass layer 12 for a convex curvature on the first major surface 18 (convex curvature with respect to the fourth major surface 26 of the second glass layer 14). In FIG. 6, a monolith was compared to a symmetrical laminate, an asymmetrical laminate with a thinner first glass layer 12, and an asymmetric laminate with a thicker first glass layer 12. Thicknesses of 0.7 mm and 2.1 mm were considered. As with Table 1, above, the slash line for thicknesses refers to the thicknesses of the first glass layer 12, the adhesive layer 16, and the second glass layer 14, respectively. As can be seen in FIG. 6, the maximum bending stress is in the monolith for both thicknesses. Further, at both thicknesses, the laminates have a lower bending stress than the monoliths. At the total thickness of 0.7 mm, the difference in thickness between the first glass layer 12 and the second glass layer 14 does not produce a large change in bending stress (less than 15 MPa difference). However, at the larger total thickness of 2.1 mm, the difference in bending stress was more pronounced. In particular, for the symmetrical laminate had a maximum bending stress of 530 MPa. The asymmetrical laminate with the thinner first glass layer 12 had a maximum bending stress of 495 MPa, whereas the asymmetrical laminate having the thicker first glass layer 12 had a maximum bending stress of 643 MPa.

Without being bound by theory, it is believed that a laminate can exhibit a smaller allowable bend radius than a monolith having the same thickness as the total thickness of the laminate.

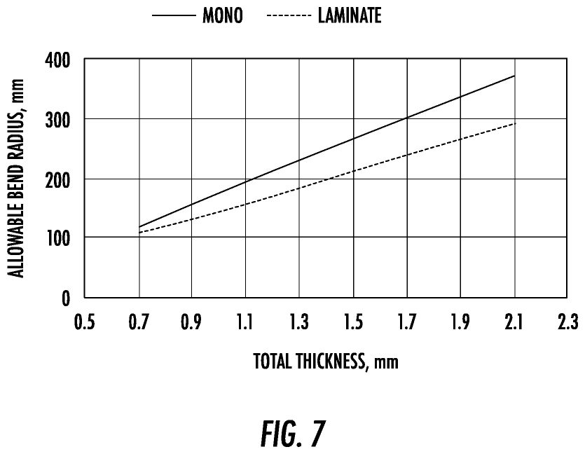

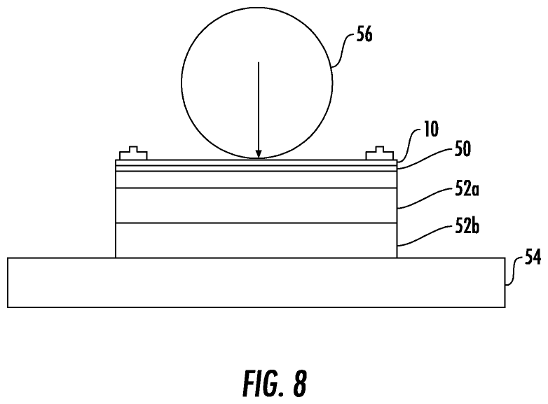

FIG. 7 depicts a graph of the allowable bend radius for the glass laminates as compared to monoliths of glass sheets having the same thickness. The glass laminates considered were symmetrical in glass layer thickness, and the adhesive layer had a shear modulus of 0.1 MPa and a thickness of 0.1 mm. The allowable bend radius is considered the tightest bend radius achievable before the monolith or one of the glass layers of laminate breaks. At a thickness of 0.7 mm, the monolith glass had an allowable bend radius of 120 mm, and the laminate had an allowable bend radius of 110 mm (tighter bend radius by 8.3%). At a thickness of 1.3 mm, the monolith glass had an allowable bend radius of 230 mm, and the laminate had an allowable bend radius of 182 mm (tighter bend radius by 20.8%). At a thickness of 2.1 mm, the monolith glass had an allowable bend radius of 370 mm, and the laminate had an allowable bend radius of 290 mm (tighter bend radius by 21.6%).

The glass laminate structures 10 described herein are believed to be particularly suitable for vehicle interior systems. Accordingly, the glass laminates were tested against relevant impact criterion for motor vehicles. In particular, the crack propagation performance mentioned above is indicative of performance according to headform impact test (HIT) according to FMVSS201 for automotive interiors. HIT is used to determine how a vehicle interior system will respond to a simulated impact from a human head during a collision. In the test, the headform weighs 6.8 kg and has a diameter of 165 mm. The headform strikes the vehicle interior at a velocity of 6.68 m/s. To pass HIT, the headform should not exceed 80 g for 3 milliseconds (ms) continuously. Additionally, while not specifically called for in the test, there is also generally a desire by manufacturers to produce laminate structures that do not break into shards after impact.

In order to investigate HIT performance, a glass laminate structure 10 was attached to a ⅛″ Derlin (polyoxymethylene) plate 50 as shown in FIG. 7. Two foam plates 52a, 52b having ½″ thickness were positioned behind the Derlin plate 50, and a steel plate 54 was positioned behind the foam plates 52a, 52b to stop the impact. The glass laminate structure 10 was hit with a headform structure 56 at the center of the of the glass laminate structure 10 in the perpendicular direction.

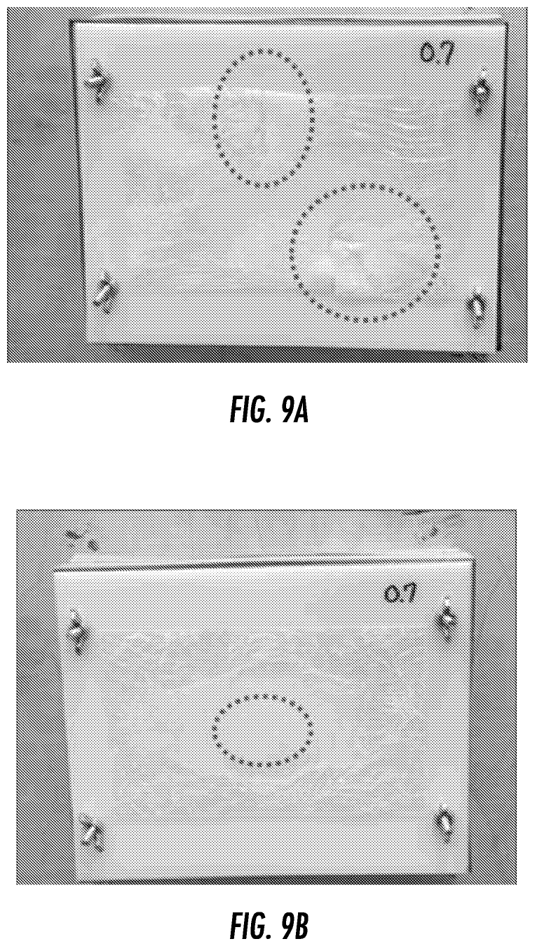

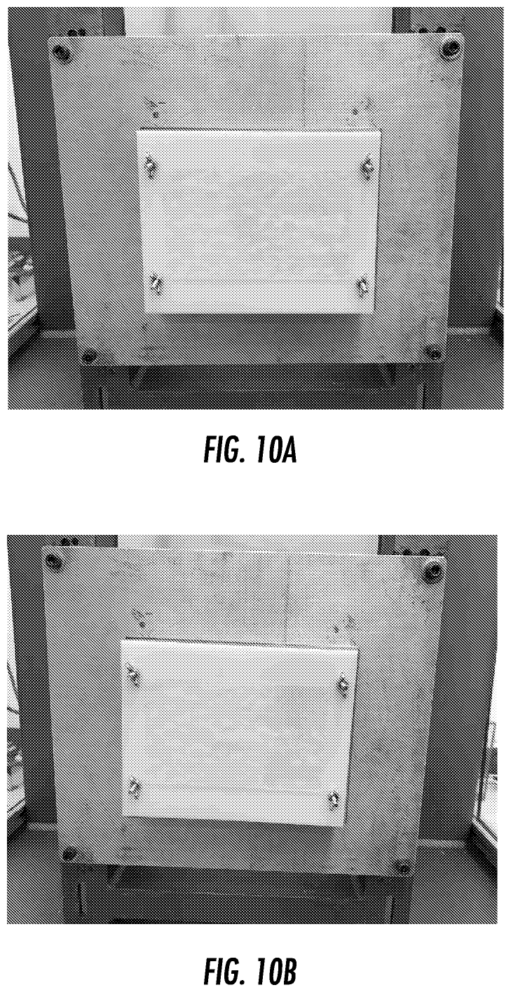

FIGS. 9A and 9B depict impacts of the headform 56 on single layers of 0.7 mm thick glass. As shown in FIGS. 9A and 9B, both glass layers failed after being impacted by the headform 56. FIG. 9A shows a first failure mode with 100% breakage including edge failure as a result of localized bending. FIG. 9B depicts surface failure resulting from global biaxial bending. FIG. 10A depicts a glass laminate structure 10 according to the present disclosure prior to HIT. The glass laminate structure 10 included two 0.55 mm glass layers and a second adhesive of OCA. FIG. 10B depicts the glass laminate structure 10 after being impacted with the headform 56. As can be seen in FIG. 10B, the glass laminate structure 10 did not fail, and no cracks or shards of glass can be seen. Using the glass laminate structure 10 of the present disclosure, surface failure can be mitigated by reducing thickness of the individual layers, and edge failure can be mitigated by increasing the total thickness. That is, as compared to a single glass layer having the same thickness as the total glass thickness of the glass laminate structure 10, the glass laminate structure 10 is able to avoid the typical failure modes associated with the thicker glass by using two thinner layers separated by an adhesive layer while also avoiding the typical failure modes associated with individual thin glass layers.

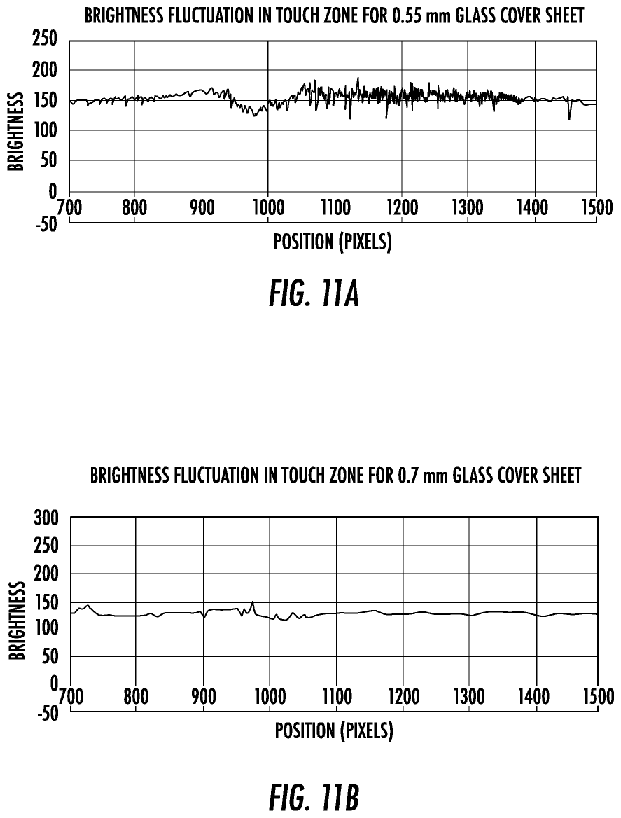

Additionally, using two layers of glass also performs better with respect to touch MURA. In general, thinner glass layers are easier to cold form, but the thin glass layers provide less resilience to a touching force than a thicker glass layer. According to the present disclosure, utilizing thin glass layers 12, 14 allows for tight bend radiuses during cold forming, approximating the bend radius achievable using a single thin glass layer, but the combined thickness remains adequate to avoid non-uniform brightness in a touch zone of a display screen. In particular, a thin glass layer will fluctuate in brightness to a larger extent than a thicker glass layer when a touching force is applied to the surface. As an example, FIGS. 11A and 11B depict two touch MURA measurements for a 0.55 mm thick cover glass layer and a 0.7 mm thick cover glass layer, respectively. As can be seen, the brightness fluctuates much more for the thinner glass layer than for the thicker glass layer. In embodiments, the maximum brightness measured when a force probe exerting 10 N of force is moved across the display screen is within 30% of the minimum brightness measured in the touch zone. In further embodiments, the maximum brightness is within 20% of the minimum brightness measured in the touch zone, and in still other embodiments, the maximum brightness is within 10% of the minimum brightness.

In various embodiments, each of the glass layers 12, 14 is formed from a strengthened glass layer (e.g., a thermally strengthened glass material, a chemically strengthened glass layer, etc.) In such embodiments, when glass layers 12, 14 are formed from a strengthened glass material, first major surface 18 and second major surface 20 are under compressive stress, and thus second major surface 20 can experience greater tensile stress during bending to the convex shape without risking fracture. This allows for strengthened glass layers 12, 14 to conform to more tightly curved surfaces.

A feature of a cold-formed glass layer is an asymmetric surface compressive between the first major surface 18 and the second major surface 20 once the glass layers 12, 14 have been bent to the curved shape. In such embodiments, prior to the cold-forming process or being cold-formed, the respective compressive stresses in the major surfaces 18, 24 and the opposing major surface 20, 26 of glass layers 12, 14 are substantially equal. After cold-forming, the compressive stress in concave regions of the second major surface 20 and of the fourth major surface 26 increases such that the compressive stress on the second major surface 20 and on the fourth major surface 26 is greater after cold-forming than before cold-forming. In contrast, convex regions of the first major surface 18 and the third major surface 24 experience tensile stresses during bending causing a net decrease in surface compressive stress on the first major surface 18 and on the third major surface 24, such that the compressive stress in the convex regions of the first major surface 18 and of the third major surface 24 following bending is less than the compressive stress in the first major surface 18 and in the third major surface 24 when the glass layer is flat. The opposite is true for the concave regions of the first and third major surfaces 18, 24 and for the convex regions of the second and fourth major surfaces 20, 36.

The various embodiments of the vehicle interior system may be incorporated into vehicles such as trains, automobiles (e.g., cars, trucks, buses and the like), sea craft (boats, ships, submarines, and the like), and aircraft (e.g., drones, airplanes, jets, helicopters and the like).

FIG. 12 shows an exemplary vehicle interior 1000 that includes three different embodiments of a vehicle interior system 1100, 1200, 1300. Vehicle interior system 1000 includes a frame, shown as center console base 1110, with a curved surface 1120 including a curved display 1130 incorporated into a center information display. Vehicle interior system 1200 includes a frame, shown as dashboard base 1210, with a curved surface 1220 including a curved display 1230 incorporated into a curved passenger-side dashboard panel. The dashboard base 1210 typically includes an instrument panel 1215 which may also include a curved display. Vehicle interior system 1300 includes a frame, shown as steering wheel base 1310, with a curved surface 1320 and a curved display 1330. In one or more embodiments, the vehicle interior system includes a frame that is an arm rest, a pillar, pillar-to-pillar, a seat back, a back seat or seats, a floor board, a headrest, a door panel, or any portion of the interior of a vehicle that includes a curved surface. In other embodiments, the frame is a portion of a housing for a free-standing display (i.e., a display that is not permanently connected to a portion of the vehicle).

The embodiments of the curved glass article described herein can be used in each of vehicle interior systems 1100, 1200 and 1300, amongst others. Further, the curved glass articles discussed herein may be used as curved cover glasses for any of the curved display embodiments discussed herein, including for use in vehicle interior systems 1100, 1200 and/or 1300. Further, in various embodiments, various non-display components of vehicle interior systems 1100, 1200 and 1300 may be formed from the glass articles discussed herein. In some such embodiments, the glass articles discussed herein may be used as the non-display cover surface for the dashboard, center console, door panel, etc. In such embodiments, glass material may be selected based on its weight, aesthetic appearance, etc. and may be provided with a coating (e.g., an ink or pigment coating) with a pattern (e.g., a brushed metal appearance, a wood grain appearance, a leather appearance, a colored appearance, etc.) to visually match the glass components with adjacent non-glass components. In specific embodiments, such ink or pigment coating may have a transparency level that provides for deadfront functionality.

### Strengthened Glass Properties

The glass layers 12, 14 may be strengthened. In one or more embodiments, glass layers 12, 14 may be strengthened to include compressive stress that extends from a surface to a depth of layer (DOL). The compressive stress regions are balanced by a central portion exhibiting a tensile stress. At the DOL, the stress crosses from a positive (compressive) stress to a negative (tensile) stress.

In various embodiments, glass layers 12, 14 may be strengthened mechanically by utilizing a mismatch of the coefficient of thermal expansion between portions of the article to create a compressive stress region and a central region exhibiting a tensile stress. In some embodiments, the glass layer may be strengthened thermally by heating the glass to a temperature above the glass transition point and then rapidly quenching.

In various embodiments, glass layers 12, 14 may be chemically strengthened by ion exchange. In the ion exchange process, ions at or near the surface of the glass layer are replaced by—or exchanged with—larger ions having the same valence or oxidation state. In those embodiments in which the glass layer comprises an alkali aluminosilicate glass, ions in the surface layer of the article and the larger ions are monovalent alkali metal cations, such as Li⁺, Na⁺, K⁺, Rb⁺, and Cs⁺. Alternatively, monovalent cations in the surface layer may be replaced with monovalent cations other than alkali metal cations, such as Ag⁺ or the like. In such embodiments, the monovalent ions (or cations) exchanged into the glass layer generate a stress.

Ion exchange processes are typically carried out by immersing a glass layer in a molten salt bath (or two or more molten salt baths) containing the larger ions to be exchanged with the smaller ions in the glass layer. It should be noted that aqueous salt baths may also be utilized. In addition, the composition of the bath(s) may include more than one type of larger ions (e.g., Na+ and K+) or a single larger ion. It will be appreciated by those skilled in the art that parameters for the ion exchange process, including, but not limited to, bath composition and temperature, immersion time, the number of immersions of the glass layer in a salt bath (or baths), use of multiple salt baths, additional steps such as annealing, washing, and the like, are generally determined by the composition of the glass layer (including the structure of the article and any crystalline phases present) and the desired DOL and CS of the glass layer that results from strengthening. Exemplary molten bath compositions may include nitrates, sulfates, and chlorides of the larger alkali metal ion. Typical nitrates include KNO₃, NaNO₃, LiNO₃, NaSO₄ and combinations thereof. The temperature of the molten salt bath typically is in a range from about 380° C. up to about 450° C., while immersion times range from about 15 minutes up to about 100 hours depending on glass layer thickness, bath temperature and glass (or monovalent ion) diffusivity. However, temperatures and immersion times different from those described above may also be used.

In one or more embodiments, the glass layers may be immersed in a molten salt bath of 100% NaNO₃, 100% KNO₃, or a combination of NaNO₃ and KNO₃ having a temperature from about 370° C. to about 480° C. In some embodiments, the glass layer may be immersed in a molten mixed salt bath including from about 5% to about 90% KNO₃ and from about 10% to about 95% NaNO₃. In one or more embodiments, the glass layer may be immersed in a second bath, after immersion in a first bath. The first and second baths may have different compositions and/or temperatures from one another. The immersion times in the first and second baths may vary. For example, immersion in the first bath may be longer than the immersion in the second bath.

In one or more embodiments, the glass layer may be immersed in a molten, mixed salt bath including NaNO₃ and KNO₃ (e.g., 49%/51%, 50%/50%, 51%/49%) having a temperature less than about 420° C. (e.g., about 400° C. or about 380° C.). for less than about 5 hours, or even about 4 hours or less.

Ion exchange conditions can be tailored to provide a “spike” or to increase the slope of the stress profile at or near the surface of the resulting glass layer. The spike may result in a greater surface CS value. This spike can be achieved by a single bath or multiple baths, with the bath(s) having a single composition or mixed composition, due to the unique properties of the glass compositions used in the glass layers described herein.

In one or more embodiments, where more than one monovalent ion is exchanged into the glass layer, the different monovalent ions may exchange to different depths within the glass layer (and generate different magnitudes stresses within the glass layer at different depths). The resulting relative depths of the stress-generating ions can be determined and cause different characteristics of the stress profile.

CS is measured using those means known in the art, such as by surface stress meter (FSM) using commercially available instruments such as the FSM-6000, manufactured by Orihara Industrial Co., Ltd. (Japan). Surface stress measurements rely upon the accurate measurement of the stress optical coefficient (SOC), which is related to the birefringence of the glass. SOC in turn is measured by those methods that are known in the art, such as fiber and four point bend methods, both of which are described in ASTM standard C770-98 (2013), entitled “Standard Test Method for Measurement of Glass Stress-Optical Coefficient,” the contents of which are incorporated herein by reference in their entirety, and a bulk cylinder method. As used herein CS may be the “maximum compressive stress” which is the highest compressive stress value measured within the compressive stress layer. In some embodiments, the maximum compressive stress is located at the surface of the glass layer. In other embodiments, the maximum compressive stress may occur at a depth below the surface, giving the compressive profile the appearance of a “buried peak.”

DOL may be measured by FSM or by a scattered light polariscope (SCALP) (such as the SCALP-04 scattered light polariscope available from Glasstress Ltd., located in Tallinn Estonia), depending on the strengthening method and conditions. When the glass layer is chemically strengthened by an ion exchange treatment, FSM or SCALP may be used depending on which ion is exchanged into the glass layer. Where the stress in the glass layer is generated by exchanging potassium ions into the glass layer, FSM is used to measure DOL. Where the stress is generated by exchanging sodium ions into the glass layer, SCALP is used to measure DOL. Where the stress in the glass layer is generated by exchanging both potassium and sodium ions into the glass, the DOL is measured by SCALP, since it is believed the exchange depth of sodium indicates the DOL and the exchange depth of potassium ions indicates a change in the magnitude of the compressive stress (but not the change in stress from compressive to tensile); the exchange depth of potassium ions in such glass layers is measured by FSM. Central tension or CT is the maximum tensile stress and is measured by SCALP.

In one or more embodiments, the glass layers may be strengthened to exhibit a DOL that is described as a fraction of the thickness T1 of the glass layer 12 (as described herein). The glass layers may also be strengthened to exhibit a DOL that is described as a fraction of the thickness T2 of the glass layer 14, and therefore, the following discussion applies as well to the glass layer 14. For example, in one or more embodiments, the DOL may be equal to or greater than about 0.05T1, equal to or greater than about 0.1T1, equal to or greater than about 0.11T1, equal to or greater than about 0.12T1, equal to or greater than about 0.13T1, equal to or greater than about 0.14T1, equal to or greater than about 0.15T1, equal to or greater than about 0.16T1, equal to or greater than about 0.17T1, equal to or greater than about 0.18T1, equal to or greater than about 0.19T1, equal to or greater than about 0.2T1, equal to or greater than about 0.21T1. In some embodiments, the DOL may be in a range from about 0.08T1 to about 0.25T1, from about 0.09T1 to about 0.25T1, from about 0.18T1 to about 0.25T1, from about 0.11T1 to about 0.25T1, from about 0.12T1 to about 0.25T1, from about 0.13T1 to about 0.25T1, from about 0.14T1 to about 0.25T1, from about 0.15T1 to about 0.25T1, from about 0.08T1 to about 0.24T1, from about 0.08T1 to about 0.23T1, from about 0.08T1 to about 0.22T1, from about 0.08T1 to about 0.21T1, from about 0.08T1 to about 0.2T1, from about 0.08T1 to about 0.19T1, from about 0.08T1 to about 0.18T1, from about 0.08T1 to about 0.17T1, from about 0.08T1 to about 0.16T1, or from about 0.08T1 to about 0.15T1. In some instances, the DOL may be about 20 μm or less. In one or more embodiments, the DOL may be about 40 μm or greater (e.g., from about 40 μm to about 300 μm, from about 50 μm to about 300 μm, from about 60 μm to about 300 μm, from about 70 μm to about 300 μm, from about 80 μm to about 300 μm, from about 90 μm to about 300 μm, from about 100 μm to about 300 μm, from about 110 μm to about 300 μm, from about 120 μm to about 300 μm, from about 140 μm to about 300 μm, from about 150 μm to about 300 μm, from about 40 μm to about 290 μm, from about 40 μm to about 280 μm, from about 40 μm to about 260 μm, from about 40 μm to about 250 μm, from about 40 μm to about 240 μm, from about 40 μm to about 230 μm, from about 40 μm to about 220 μm, from about 40 μm to about 210 μm, from about 40 μm to about 200 μm, from about 40 μm to about 180 μm, from about 40 μm to about 160 μm, from about 40 μm to about 150 μm, from about 40 μm to about 140 μm, from about 40 μm to about 130 μm, from about 40 μm to about 120 μm, from about 40 μm to about 110 μm, or from about 40 μm to about 100 μm. In other embodiments, DOL falls within any one of the exact numerical ranges set forth in this paragraph.

In one or more embodiments, the strengthened glass layers 12, 14 may have a CS (which may be found at the surface or a depth within the glass layer) of about 200 MPa or greater, 300 MPa or greater, 400 MPa or greater, about 500 MPa or greater, about 600 MPa or greater, about 700 MPa or greater, about 800 MPa or greater, about 900 MPa or greater, about 930 MPa or greater, about 1000 MPa or greater, or about 1050 MPa or greater.

In one or more embodiments, the strengthened glass layers 12, 14 may have a maximum tensile stress or central tension (CT) of about 20 MPa or greater, about 30 MPa or greater, about 40 MPa or greater, about 45 MPa or greater, about 50 MPa or greater, about 60 MPa or greater, about 70 MPa or greater, about 75 MPa or greater, about 80 MPa or greater, or about 85 MPa or greater. In some embodiments, the maximum tensile stress or central tension (CT) may be in a range from about 40 MPa to about 100 MPa. In other embodiments, CS falls within the exact numerical ranges set forth in this paragraph.

### Glass Compositions

Suitable glass compositions for use in glass layers 12, 14 include soda lime silicate glass, aluminosilicate glass, borosilicate glass, boroaluminosilicate glass, alkali-containing aluminosilicate glass, alkali-containing borosilicate glass, and alkali-containing boroaluminosilicate glass. In one or more embodiments, the first and second glass layers may differ from one another compositionally, in thickness, in strength level or in strengthening technique. For example, the first glass layer may comprise an aluminosilicate glass composition while the second glass layer may comprise a soda lime silicate composition.

Unless otherwise specified, the glass compositions disclosed herein are described in mole percent (mol %) as analyzed on an oxide basis.

In one or more embodiments, the glass composition may include SiO₂ in an amount in a range from about 66 mol % to about 80 mol %, from about 67 mol % to about 80 mol %, from about 68 mol % to about 80 mol %, from about 69 mol % to about 80 mol %, from about 70 mol % to about 80 mol %, from about 72 mol % to about 80 mol %, from about 65 mol % to about 78 mol %, from about 65 mol % to about 76 mol %, from about 65 mol % to about 75 mol %, from about 65 mol % to about 74 mol %, from about 65 mol % to about 72 mol %, or from about 65 mol % to about 70 mol %, and all ranges and sub-ranges therebetween.

In one or more embodiments, the glass composition includes Al₂O₃ in an amount greater than about 4 mol %, or greater than about 5 mol %. In one or more embodiments, the glass composition includes Al₂O₃ in a range from greater than about 7 mol % to about 15 mol %, from greater than about 7 mol % to about 14 mol %, from about 7 mol % to about 13 mol %, from about 4 mol % to about 12 mol %, from about 7 mol % to about 11 mol %, from about 8 mol % to about 15 mol %, from about 9 mol % to about 15 mol %, from about 10 mol % to about 15 mol %, from about 11 mol % to about 15 mol %, or from about 12 mol % to about 15 mol %, and all ranges and sub-ranges therebetween. In one or more embodiments, the upper limit of Al₂O₃ may be about 14 mol %, 14.2 mol %, 14.4 mol %, 14.6 mol %, or 14.8 mol %.

In one or more embodiments, the glass article is described as an aluminosilicate glass article or including an aluminosilicate glass composition. In such embodiments, the glass composition or article formed therefrom includes SiO₂ and Al₂O₃ and is not a soda lime silicate glass. In this regard, the glass composition or article formed therefrom includes Al₂O₃ in an amount of about 2 mol % or greater, 2.25 mol % or greater, 2.5 mol % or greater, about 2.75 mol % or greater, about 3 mol % or greater.

In one or more embodiments, the glass composition comprises B₂O₃ (e.g., about 0.01 mol % or greater). In one or more embodiments, the glass composition comprises B₂O₃ in an amount in a range from about 0 mol % to about 5 mol %, from about 0 mol % to about 4 mol %, from about 0 mol % to about 3 mol %, from about 0 mol % to about 2 mol %, from about 0 mol % to about 1 mol %, from about 0 mol % to about 0.5 mol %, from about 0.1 mol % to about 5 mol %, from about 0.1 mol % to about 4 mol %, from about 0.1 mol % to about 3 mol %, from about 0.1 mol % to about 2 mol %, from about 0.1 mol % to about 1 mol %, from about 0.1 mol % to about 0.5 mol %, and all ranges and sub-ranges therebetween. In one or more embodiments, the glass composition is substantially free of B₂O₃.

As used herein, the phrase “substantially free” with respect to the components of the composition means that the component is not actively or intentionally added to the composition during initial batching, but may be present as an impurity in an amount less than about 0.001 mol %.

In one or more embodiments, the glass composition optionally comprises P₂O₅ (e.g., about 0.01 mol % or greater). In one or more embodiments, the glass composition comprises a non-zero amount of P₂O₅ up to and including 2 mol %, 1.5 mol %, 1 mol %, or 0.5 mol %. In one or more embodiments, the glass composition is substantially free of P₂O₅.

In one or more embodiments, the glass composition may include a total amount of R₂O (which is the total amount of alkali metal oxide such as Li₂O, Na₂O, K₂O, Rb₂O, and Cs₂O) that is greater than or equal to about 8 mol %, greater than or equal to about 10 mol %, or greater than or equal to about 12 mol %. In some embodiments, the glass composition includes a total amount of R₂O in a range from about 8 mol % to about 20 mol %, from about 8 mol % to about 18 mol %, from about 8 mol % to about 16 mol %, from about 8 mol % to about 14 mol %, from about 8 mol % to about 12 mol %, from about 9 mol % to about 20 mol %, from about 10 mol % to about 20 mol %, from about 11 mol % to about 20 mol %, from about 12 mol % to about 20 mol %, from about 13 mol % to about 20 mol %, from about 10 mol % to about 14 mol %, or from 11 mol % to about 13 mol %, and all ranges and sub-ranges therebetween. In one or more embodiments, the glass composition may be substantially free of Rb₂O, Cs₂O or both Rb₂O and Cs₂O. In one or more embodiments, the R₂O may include the total amount of Li₂O, Na₂O and K₂O only. In one or more embodiments, the glass composition may comprise at least one alkali metal oxide selected from Li₂O, Na₂O and K₂O, wherein the alkali metal oxide is present in an amount greater than about 8 mol % or greater.

In one or more embodiments, the glass composition comprises Na₂O in an amount greater than or equal to about 8 mol %, greater than or equal to about 10 mol %, or greater than or equal to about 12 mol %. In one or more embodiments, the composition includes Na₂O in a range from about from about 8 mol % to about 20 mol %, from about 8 mol % to about 18 mol %, from about 8 mol % to about 16 mol %, from about 8 mol % to about 14 mol %, from about 8 mol % to about 12 mol %, from about 9 mol % to about 20 mol %, from about 10 mol % to about 20 mol %, from about 11 mol % to about 20 mol %, from about 12 mol % to about 20 mol %, from about 13 mol % to about 20 mol %, from about 10 mol % to about 14 mol %, or from 11 mol % to about 16 mol %, and all ranges and sub-ranges therebetween.

In one or more embodiments, the glass composition includes less than about 4 mol % K₂O, less than about 3 mol % K₂O, or less than about 1 mol % K₂O. In some instances, the glass composition may include K₂O in an amount in a range from about 0 mol % to about 4 mol %, from about 0 mol % to about 3.5 mol %, from about 0 mol % to about 3 mol %, from about 0 mol % to about 2.5 mol %, from about 0 mol % to about 2 mol %, from about 0 mol % to about 1.5 mol %, from about 0 mol % to about 1 mol %, from about 0 mol % to about 0.5 mol %, from about 0 mol % to about 0.2 mol %, from about 0 mol % to about 0.1 mol %, from about 0.5 mol % to about 4 mol %, from about 0.5 mol % to about 3.5 mol %, from about 0.5 mol % to about 3 mol %, from about 0.5 mol % to about 2.5 mol %, from about 0.5 mol % to about 2 mol %, from about 0.5 mol % to about 1.5 mol %, or from about 0.5 mol % to about 1 mol %, and all ranges and sub-ranges therebetween. In one or more embodiments, the glass composition may be substantially free of K₂O.

In one or more embodiments, the glass composition is substantially free of Li₂O.

In one or more embodiments, the amount of Na₂O in the composition may be greater than the amount of Li₂O. In some instances, the amount of Na₂O may be greater than the combined amount of Li₂O and K₂O. In one or more alternative embodiments, the amount of Li₂O in the composition may be greater than the amount of Na₂O or the combined amount of Na₂O and K₂O.

In one or more embodiments, the glass composition may include a total amount of RO (which is the total amount of alkaline earth metal oxide such as CaO, MgO, BaO, ZnO and SrO) in a range from about 0 mol % to about 2 mol %. In some embodiments, the glass composition includes a non-zero amount of RO up to about 2 mol %. In one or more embodiments, the glass composition comprises RO in an amount from about 0 mol % to about 1.8 mol %, from about 0 mol % to about 1.6 mol %, from about 0 mol % to about 1.5 mol %, from about 0 mol % to about 1.4 mol %, from about 0 mol % to about 1.2 mol %, from about 0 mol % to about 1 mol %, from about 0 mol % to about 0.8 mol %, from about 0 mol % to about 0.5 mol %, and all ranges and sub-ranges therebetween.

In one or more embodiments, the glass composition includes CaO in an amount less than about 1 mol %, less than about 0.8 mol %, or less than about 0.5 mol %. In one or more embodiments, the glass composition is substantially free of CaO.

In some embodiments, the glass composition comprises MgO in an amount from about 0 mol % to about 7 mol %, from about 0 mol % to about 6 mol %, from about 0 mol % to about 5 mol %, from about 0 mol % to about 4 mol %, from about 0.1 mol % to about 7 mol %, from about 0.1 mol % to about 6 mol %, from about 0.1 mol % to about 5 mol %, from about 0.1 mol % to about 4 mol %, from about 1 mol % to about 7 mol %, from about 2 mol % to about 6 mol %, or from about 3 mol % to about 6 mol %, and all ranges and sub-ranges therebetween.

In one or more embodiments, the glass composition comprises ZrO₂ in an amount equal to or less than about 0.2 mol %, less than about 0.18 mol %, less than about 0.16 mol %, less than about 0.15 mol %, less than about 0.14 mol %, less than about 0.12 mol %. In one or more embodiments, the glass composition comprises ZrO₂ in a range from about 0.01 mol % to about 0.2 mol %, from about 0.01 mol % to about 0.18 mol %, from about 0.01 mol % to about 0.16 mol %, from about 0.01 mol % to about 0.15 mol %, from about 0.01 mol % to about 0.14 mol %, from about 0.01 mol % to about 0.12 mol %, or from about 0.01 mol % to about 0.10 mol %, and all ranges and sub-ranges therebetween.

In one or more embodiments, the glass composition comprises SnO₂ in an amount equal to or less than about 0.2 mol %, less than about 0.18 mol %, less than about 0.16 mol %, less than about 0.15 mol %, less than about 0.14 mol %, less than about 0.12 mol %. In one or more embodiments, the glass composition comprises SnO₂ in a range from about 0.01 mol % to about 0.2 mol %, from about 0.01 mol % to about 0.18 mol %, from about 0.01 mol % to about 0.16 mol %, from about 0.01 mol % to about 0.15 mol %, from about 0.01 mol % to about 0.14 mol %, from about 0.01 mol % to about 0.12 mol %, or from about 0.01 mol % to about 0.10 mol %, and all ranges and sub-ranges therebetween.

In one or more embodiments, the glass composition may include an oxide that imparts a color or tint to the glass articles. In some embodiments, the glass composition includes an oxide that prevents discoloration of the glass article when the glass article is exposed to ultraviolet radiation. Examples of such oxides include, without limitation oxides of: Ti, V, Cr, Mn, Fe, Co, Ni, Cu, Ce, W, and Mo.

In one or more embodiments, the glass composition includes Fe expressed as Fe₂O₃, wherein Fe is present in an amount up to (and including) about 1 mol %. In some embodiments, the glass composition is substantially free of Fe. In one or more embodiments, the glass composition comprises Fe₂O₃ in an amount equal to or less than about 0.2 mol %, less than about 0.18 mol %, less than about 0.16 mol %, less than about 0.15 mol %, less than about 0.14 mol %, less than about 0.12 mol %. In one or more embodiments, the glass composition comprises Fe₂O₃ in a range from about 0.01 mol % to about 0.2 mol %, from about 0.01 mol % to about 0.18 mol %, from about 0.01 mol % to about 0.16 mol %, from about 0.01 mol % to about 0.15 mol %, from about 0.01 mol % to about 0.14 mol %, from about 0.01 mol % to about 0.12 mol %, or from about 0.01 mol % to about 0.10 mol %, and all ranges and sub-ranges therebetween.

Where the glass composition includes TiO₂, TiO₂ may be present in an amount of about 5 mol % or less, about 2.5 mol % or less, about 2 mol % or less or about 1 mol % or less. In one or more embodiments, the glass composition may be substantially free of TiO₂.

An exemplary glass composition includes SiO₂ in an amount in a range from about 65 mol % to about 75 mol %, Al₂O₃ in an amount in a range from about 8 mol % to about 14 mol %, Na₂O in an amount in a range from about 12 mol % to about 17 mol %, K₂O in an amount in a range of about 0 mol % to about 0.2 mol %, and MgO in an amount in a range from about 1.5 mol % to about 6 mol %. Optionally, SnO₂ may be included in the amounts otherwise disclosed herein. It should be understood, that while the preceding glass composition paragraphs express approximate ranges, in other embodiments, glass layers 12, 14 may be made from any glass composition falling with any one of the exact numerical ranges discussed above.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is in no way intended that any particular order be inferred. In addition, as used herein, the article “a” is intended to include one or more than one component or element, and is not intended to be construed as meaning only one.

It will be apparent to those skilled in the art that various modifications and variations can be made without departing from the spirit or scope of the disclosed embodiments. Since modifications, combinations, sub-combinations and variations of the disclosed embodiments incorporating the spirit and substance of the embodiments may occur to persons skilled in the art, the disclosed embodiments should be construed to include everything within the scope of the appended claims and their equivalents.

1. A method for forming a vehicle interior system, comprising the steps of:
providing a first glass layer having a first major surface and a second major surface, the second major surface being opposite to the first major surface;
providing a second glass layer having third major surface and a fourth major surface, the fourth major surface being opposite to the third major surface;
bonding the second major surface to the third major surface with an adhesive layer to form a glass laminate;
placing the glass laminate on a mold; and
forming a first curvature in the glass laminate at a temperature below a first glass transition temperature of the first glass layer and below a second glass transition temperature of the second glass layer.

2. The method of claim 1, wherein the step of forming further comprises vacuum forming the first curvature in the glass laminate.

3. The method of claim 1, wherein the adhesive layer comprises a first adhesive and a second adhesive and wherein the step of bonding the second major surface to the third major surface comprises applying the first adhesive to a non-display region of the first and second glass layers and the second adhesive to a display region of the first and second glass layers.

4. The method of claim 3, wherein:
the first adhesive comprises at least one of a pressure-sensitive adhesive, a UV-curable adhesive, a toughened epoxy, a flexible epoxy, an acrylic, a silicone, a urethane, a polyurethane, or a silane-modified polymer, and
a Young's modulus of the first adhesive is at least 100 MPa.

5. (canceled)

6. The method of claim 3, wherein:
the second adhesive comprises an optically clear adhesive comprising a Young's modulus in a range from about 10 kPa to about 100 kPa and a shear modulus of 100 kPa or less.

7. (canceled)

8. (canceled)

9. The method of claim 1, wherein the first major surface and the second major surface define a first thickness of the first glass layer and the third major surface and the fourth major surface define a second thickness of the second glass layer and wherein the first thickness and the second thickness have a combined thickness of from 0.2 mm to 5 mm, the first thickness is from 0.1 mm to 2.5 mm, and the second thickness is from 0.1 mm to 2.5 mm.

10. (canceled)

11. (canceled)

12. (canceled)

13. (canceled)

14. The method of claim 1, wherein at least one of the first glass layer or the second glass layer comprises at least one of a soda lime silicate glass, an aluminosilicate glass, an alkali aluminosilicate glass, or a borosilicate glass.

15. The method of claim 1, wherein the first curvature has a radius of curvature of from 100 mm to 5 m and wherein the step of cold forming is performed at a temperature of no more than 200° C.

16. (canceled)

17. A glass laminate for a vehicle interior system, comprising:
a first glass layer having a first curved surface and a second curved surface, the first curved surface and the second curved surface being on opposite sides of the first glass layer and defining a first thickness of the first glass layer;
a second glass layer having third curved surface and a fourth curved surface, the third curved surface and the fourth curved surface being on opposite sides of the second glass layer and defining a second thickness of the second glass layer; and
an adhesive layer disposed between the second curved surface and the third curved surface, the adhesive layer bonding the first glass layer to the second glass layer;
wherein the first curved surface, the second curved surface, the third curved surface, and the fourth curved surface define at least a first curvature of the glass laminate; and
wherein a maximum deceleration of a head form impacting the first curved surface of the first glass layer does not exceed 80 g for 3 ms continuously when tested according to FMVSS201.

18. The glass laminate of claim 17, wherein the adhesive layer comprises a first adhesive and a second adhesive and wherein the first adhesive is applied in a non-display region of the first and second glass layers and the second adhesive is applied in a display region of the first and second glass layers.

19. The glass laminate of claim 18, wherein the first adhesive comprises at least one of a pressure-sensitive adhesive, a UV-curable adhesive, a toughened epoxy, a flexible epoxy, an acrylic, a silicone, a urethane, a polyurethane, or a silane-modified polymer and wherein a Young's modulus of the first adhesive is at least 100 MPa.

20. (canceled)

21. The glass laminate of claim 18, wherein the second adhesive comprises an optically clear adhesive and wherein a Young's modulus of the optically clear adhesive from 10 kPa to 100 kPa.

22. (canceled)

23. The glass laminate of claim 17, wherein the first thickness and the second thickness have a combined thickness of from 0.2 mm to 5 mm.

24. (canceled)

25. (canceled)

26. The glass laminate of claim 17, wherein at least one of the first curved surface, the second curved surface, the third curved surface, or the fourth curved surface comprises a surface treatment and wherein the surface treatment comprises at least one of anti-glare, anti-reflection, easy-to-clean, or decorative layer.

27. (canceled)

28. The glass laminate of claim 17, wherein at least one of the first glass layer or the second glass layer comprises at least one of a soda lime silicate glass, an aluminosilicate glass, an alkali aluminosilicate glass, or a borosilicate glass.

29. The glass laminate of claim 17, wherein the first curvature has a radius of curvature of from 100 mm to 5 m.

30. The glass laminate of claim 17, further comprising a second curvature, the second curvature having a radius of curvature of from 100 mm to 5 m, wherein at least one of the first curvature or the second curvature is concave and wherein at least one of the first curvature or the second curvature is convex.

31. (canceled)

32. (canceled)

33. (canceled)

34. A vehicle interior system, comprising:
a glass laminate comprising a first curvature and having a display region and a non-display region, the glass laminate comprising:
a first glass layer having a first major surface and a second major surface, the second major surface being opposite to the first major surface;
a second glass layer having third major surface and a fourth major surface, the fourth major surface being opposite to the third major surface; and
an adhesive layer disposed between the second major surface and the third major surface, the adhesive layer bonding the first glass layer to the second glass layer; and
a display bonded to the fourth major surface in a display region of the glass laminate;
wherein, when a probe applying 10 N of force to the glass laminate is moved across the first major surface in the display region, a maximum brightness of light from the display measured by the probe is within 30% of a minimum brightness measured by the probe.

35. The vehicle interior system of claim 34, wherein a maximum deceleration of a head form impacting the first major surface of the first glass layer does not exceed 80 g for 3 ms continuously when tested according to FMVSS201.

36. The vehicle interior system of claim 34, wherein:
the adhesive layer comprises a first adhesive in non-display regions, the first adhesive comprising at least one of a pressure-sensitive adhesive, a UV-curable adhesive, a toughened epoxy, a flexible epoxy, an acrylic, a silicone, a urethane, a polyurethane, or a silane-modified polymer,
a Young's modulus of the first adhesive is at least 100 MPa,
the adhesive layer comprises a second adhesive in the display region, the second adhesive comprising an optically clear adhesive, and
the optically clear adhesive comprises a Young's modulus of from 10 kPa to 100 kPa.

37-54. (canceled)
